(19) United States
(12) Patent Application Publication
(10) Pub. No.: US 2026/0279755 A1
(43) Pub. Date: Sep. 17, 2026

(54) Miniature multipole

(71) Applicant: Thermo Fisher Scientific (Bremen) GmbH, Bremen (DE)

(72) Inventor: Wilko Balschun, Hude (DE)

(21) Appl. No.: 19/565,074

(22) Filed: Mar. 12, 2026

(30) Foreign Application Priority Data
Mar. 14, 2025 (GB) 2503759.9

(51) Int. Cl. H01J 49/06

(52) U.S. Cl. CPC H01J 49/063

(57) ABSTRACT

A method of manufacturing a multipole ion guide is provided. The method comprises providing a metal part, cutting the metal part by wire erosion in a first step to create a plurality of multipole electrodes that each extend generally along an axial (z) direction, wherein the plurality of multipole electrodes includes a plurality of RF electrodes and one or more axial DC gradient electrodes, and cutting the metal part by wire erosion in a second step to shape each of the one or more axial DC gradient electrodes. In the first wire erosion step, a wire erosion wire is arranged to extend in a first direction, wherein the first direction is substantially parallel to the axial (z) direction. In the second wire erosion step, a wire erosion wire is arranged to extend in one or more second direction(s), wherein each second direction is arranged at a non-zero angle relative to the first direction.

This application is based on pending U.K. Application No. GB2503759.9, filed Mar. 14, 2025. The entire contents of the aforementioned application are incorporated by reference herein.

### FIELD OF THE INVENTION

The present invention relates to the field of mass spectrometry, and in particularly to multipoles such as quadrupoles.

### BACKGROUND

Radiofrequency (RF) powered multipoles are widely used in mass spectrometry for ion transport and focusing, where ions are focused by collisions with an inert buffer gas (e.g., as described in U.S. Pat. Nos. 4,963,736, 5,652,427, 5,847,386, and others). Typically, such guides have inscribed radii of several millimetres and lengths of tens to hundreds of millimetres, although much longer multipoles can also be constructed. With the integral of the gas pressure P along the axis of the guide ∫Pdx>0.2 mm*mbar, ion beams can be focused to less than one hundred or a few hundred micrometres outer diameter. However, in some applications, tighter focusing is required, requiring beam sizes of ten or fewer microns to be achieved.

WO 2024/153,498 describes an ion carpet integrated with a miniature quadrupole which can be used for “soft landing”, focused ion beams, or very small ion beams for miniaturised ion traps.

U.S. Pat. No. 7,351,963 describes a multiple rod systems produced by wire erosion.

It is believed that there remains scope for improvements to apparatus and methods for mass spectrometry.

### SUMMARY

A first aspect provides a method of manufacturing a multipole comprising:
providing a metal part;
cutting the metal part by wire erosion in a first step to create a plurality of multipole electrodes that each extend generally along an axial (z) direction, wherein the plurality of multipole electrodes includes a plurality of RF electrodes and one or more axial DC gradient electrodes; and
cutting the metal part by wire erosion in a second step to shape each of the one or more axial DC gradient electrodes;
wherein in the first wire erosion step, a wire erosion wire is arranged to extend in a first direction, wherein the first direction is substantially parallel to the axial (z) direction; and
wherein in the second wire erosion step, a wire erosion wire is arranged to extend in one or more second direction(s), wherein each second direction is arranged at a non-zero angle relative to the first direction.

The same wire erosion machine may be used in the first and second wire erosion steps, and the method may comprises tilting the wire erosion wire between the first wire erosion step and the second wire erosion step.

Each second direction may be arranged at a non-zero angle <5°, <2° or <1° relative to the first direction. Each second direction may be arranged at an angle >0.1°, >0.2° or >0.5° relative to the first direction.

The plurality of multipole electrodes may include a plurality of axial DC gradient electrodes. In the second wire erosion step, each axial DC gradient electrode may be cut such that the axial DC gradient electrodes together have a substantially conical profile.

The metal part may be a unitary metal part. The metal part may comprise a metal disc having a central hub, an outer ring, and a plurality of initial electrodes that each extend radially from the central hub towards the outer ring. In the first wire erosion step, the initial electrodes may be separated from one another.

The plurality of initial electrodes may comprise a plurality of initial RF electrodes and a plurality of initial DC electrodes. Each of the initial DC electrodes may extend radially from the central hub to the outer ring. Each of the initial RF electrodes may extend radially from the central hub some but not all of the way to the outer ring.

The initial RF electrodes and the initial DC electrodes may be arranged in an alternating pattern around the central hub. In the first wire erosion step, the initial RF electrodes may be separated from the initial DC electrodes.

The central hub may protrude from a main body of the metal disc generally in the axial (z) direction. The central hub may be in the form of a substantially frustoconical projection on one side of the disc, and a substantially conical projection on the other side of the disc.

The metal part may be attached to an electrically insulating support such as a ceramic support. The method may comprise attaching the metal part to the support by brazing.

The support may comprise a ring (e.g. a ceramic ring) having a central hole arranged within a recess. The method may comprise arranging the metal disc in the recess, with the frustoconical projection of the metal disc projecting through the central hole.

A surface of the recess may be substantially flat. A surface of the main body of the metal disc may be substantially flat. The method may comprise bonding the flat surface of the metal disc to the flat surface of the recess by brazing.

The ring may comprise a plurality of alignment holes arranged within the recess. The metal disc may comprise a plurality of alignment holes, with each alignment hole corresponding to a respective one of the alignment holes of the ring. The step of arranging the metal disc in the recess may comprise aligning the alignment holes of the metal disc with the alignment holes of the ring.

The method may comprise machining the conical projection by turning after attaching the metal part to the insulating support.

The method may comprise cutting the metal part by wire erosion to shape the plurality of alignment holes, e.g. after attaching the metal part to the insulating support, optionally as part of the first wire erosion step.

The metal part may be formed from a nickel-cobalt ferrous alloy having substantially the same thermal expansion characteristics as ceramic.

The wire erosion wire may have a diameter <0.5 mm or <0.2 mm, such as around 0.1 mm. The plurality of multipole electrodes may be separated from one another by gaps, with each gap having a width <0.5 mm or <0.2 mm, such as around 0.15 mm. The plurality of multipole electrodes may each have a length in the axial (z) direction of <20 mm or <15 mm, such as around 10 mm.

A further aspect provides a multipole manufactured according to the method described above.

A further aspect provides an analytical instrument, such as a mass spectrometer, comprising the multipole described above.

### DESCRIPTION OF THE DRAWINGS

Various embodiments will now be described in more detail with reference to the accompanying Figures, in which:

FIG. 1 shows schematically an analytical instrument in accordance with embodiments;

FIG. 2 shows schematically an analytical instrument in accordance with embodiments;

FIG. 3 shows schematically a cross-sectional view of a miniature quadrupole;

FIG. 4 is a flow diagram illustrating a method of manufacturing a miniature multipole in accordance with embodiments;

FIG. 5 is a perspective view of a ceramic ring used in the method of FIG. 4;

FIG. 6A is a perspective view of a metal disc used in the method of FIG. 4, and FIG. 6B is a cross-sectional view of the metal disc;

FIG. 7A is a perspective view of an assembly formed from a ceramic ring and a metal disc used in the method of FIG. 4, and FIG. 7B is a cross-sectional view of the assembly;

FIG. 8 illustrates schematically a step of machining by turning used in the method of FIG. 4;

FIG. 9A illustrates schematically a precision wire erosion cut used in the method of FIG. 4, FIG. 9B illustrates schematically a precision wire erosion cut used in the method of FIG. 4, and FIG. 9C illustrates schematically a precision wire erosion cut used in the method of FIG. 4;

FIG. 10A illustrates schematically a precision wire erosion cut used in the method of FIG. 4, and FIG. 10B illustrates schematically a precision wire erosion cut used in the method of FIG. 4;

FIG. 11A is a perspective view of a miniature quadrupole manufactured in accordance with embodiments, and FIG. 11B is a perspective view of a miniature quadrupole manufactured in accordance with embodiments; and

FIG. 12 is a cross-sectional view of the miniature quadrupole when installed in an analytical instrument.

### DETAILED DESCRIPTION

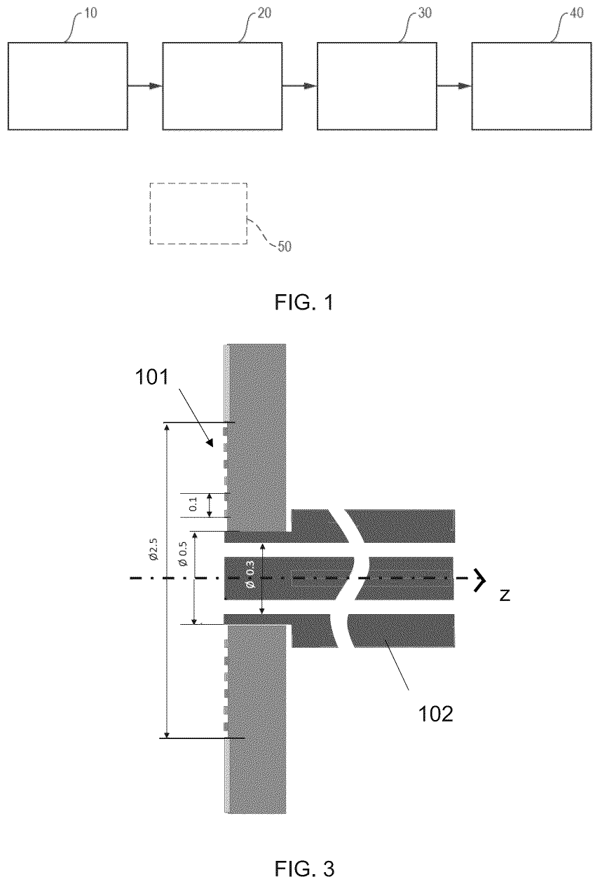

FIG. 1 illustrates schematically an analytical instrument, such as a mass spectrometer, that may be used in conjunction with the methods described herein. As shown in FIG. 1, the instrument includes an ion source 10, a mass filter 20, a fragmentation device 30, and a mass analyser 40.

The ion source 10 is configured to generate ions from a sample. The ion source 10 can be any suitable type of ion source.

The mass filter 20 is arranged downstream of the ion source 10 and is configured to receive ions from the ion source 10. The mass filter 20 is configured to filter the received ions according to their mass to charge ratio (m/z). The mass filter 20 may be operable in a transmission mode of operation, whereby most or all ions within a relatively wide m/z window are onwardly transmitted by the mass filter 20, and a filtering mode of operation, whereby only ions within a relatively narrow m/z window (centred at a desired m/z) are onwardly transmitted by the mass filter 20. The mass filter 20 can be any suitable type of mass filter, such as a quadrupole mass filter.

The fragmentation device 30 is arranged downstream of the mass filter 20 and is configured to receive most or all ions transmitted by the mass filter 20. The fragmentation device 30 may be configured to selectively fragment some or all of the received ions, i.e. so as to produce fragment ions. The fragmentation device 30 can be any suitable type of fragmentation device.

The mass analyser 40 is arranged downstream of the fragmentation device 30 and is configured to receive ions from the fragmentation device 30. Thus, the mass analyser 40 may receive unfragmented precursor ions and/or fragment ions, depending on the mode of operation of the fragmentation device 30. The mass analyser 40 is configured to analyse the received ions so as to determine their mass to charge ratio (m/z) and/or mass, i.e. to produce a mass spectrum of the ions. The mass analyser 40 can be any suitable type of mass analyser.

It should be noted that FIG. 1 is merely schematic, and that the instrument can, and in embodiments does, include any number of one or more additional components such as ion optical devices. For example, the instrument may include one or more ion transfer stage(s) arranged between any of the illustrated components, e.g. including an atmospheric pressure interface and/or one or more RF ion guides, lenses and/or other ion optical devices configured such that some or all of the ions can be transmitted appropriately through the instrument.

As also shown in FIG. 1, the instrument is under the control of a control unit 50, such as an appropriately programmed computer, which controls the operation of various components of the instrument and, for example, sets the voltages to be applied to the various components of the instrument. The control unit 50 may also receive and process data from various components including the analyser(s).

Embodiments are directed to the construction and fabrication of a miniature quadrupole for mass spectrometry. A miniature quadrupole can be used within or between any of the stages of the analytical instrument depicted in FIG. 1. For example, as described in WO 2024/153,498, a miniature quadrupole can be used, amongst other things, in mass spectrometers that require so-called “soft landing”, focused ion beams or very small ion beams for miniaturised ion traps.

FIG. 2 shows in more detail an example instrument that is configure for “soft landing”, in accordance with embodiments. It will be understood that the instrument shown in FIG. 2 is a non-limiting example, and that numerous variations are possible.

As shown in FIG. 2, the instrument includes a vacuum interface, which includes a transfer tube 21, an ion funnel 22, a quadrupole pre-filter ion guide 23, and a “bent flatapole” ion guide 24. The instrument also includes a mass filter in the form of a quadrupole mass filter 20, an ion trap 31 in the form of a curved linear ion trap (“C-Trap”), and a fragmentation device 30 in the form of an ion routing multipole (“IRM”). Ions from the ion source can be accumulated in the C-Trap 31 and/or fragmentation device 30 by opening and closing a gating electrode located in a charge detector assembly 25, which is arranged between the C-Trap 31 and the mass filter 20.

The instrument also includes a mass analyser 40 in the form of an orbital ion trap mass analyser. Once accumulated in the ion trap 31 and/or fragmentation device 30, ions can be ejected into the mass analyser 40 for analysis. Ions collected in the ion trap 31 can either be ejected orthogonally to the mass analyser 40 without entering the fragmentation device 30, or the ions can be transmitted axially to the fragmentation device 30 for processing before the processed ions are returned to the ion trap 31 for subsequent orthogonal ejection to the mass analyser 40. The processing may comprise, for example, fragmenting the ions in the fragmentation device 30, or further cooling the ions by collisions with a gas at lower energies that do cause the ions to fragment.

As described in WO 2024/153,498, the contents of which is incorporated herein by reference, for soft-landing use, ions can be directed from the IRM 30 via a pair of transport multipoles 60 into a second collision cell 61 where they are cooled to form ion beam, e.g. having an outer diameter (OD) of around 100-200 microns. An ion focusing device 100 in the form of an ion carpet coupled with a miniature quadrupole, may be used to compress the initial beam, e.g. down to around 10-30 microns OD. The resulting ion beam may be further transported to a target array 63, where it may be deposited at controllable energy. The location of landing may be adjusted using an X-Y rastering system 62 with a spot size tuned using ion-optical lenses, for example.

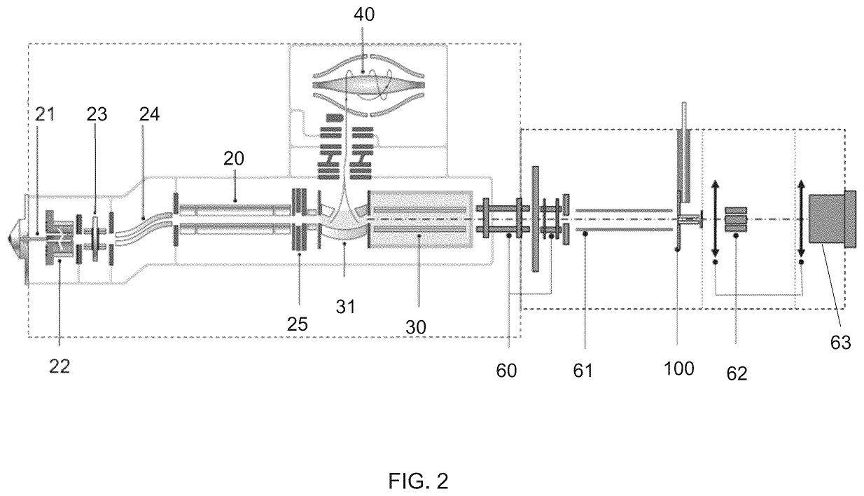

FIG. 3 illustrates the ion focusing device 100 in more detail. As shown in FIG. 3 (and as described in more detail in WO 2024/153,498), the ion focusing device 100 comprises an ion carpet 101 coupled with a miniature quadrupole 102. As also shown in FIG. 3, RF electrodes of the miniature quadrupole extend generally along an axial (z) direction. The miniature quadrupole 102 has at least two pairs of RF electrodes and a superimposed axial DC field (DC offset). The inner radius of the RF electrodes is less than or equal to 0.4 mm with a length of around 10 mm.

Production of the miniature quadrupole 102 requires very high manufacturing accuracies in the various dimensions and in the straightness and symmetry of the RF electrodes, and when installing the quadrupole in the overall analytical instrument. A reproducible manufacturing technology is needed, together with a high electrical flashover strength (e.g. 230 Vpp), compatibility with ultra-high vacuum, and compatibility with both cooling to very low temperatures (e.g. down to 77 Kelvin) and heating for bake-out (e.g. at about 100° C.). The miniature quadrupole can be flooded with gas on the inlet side and should provide good access for pumping on the outlet side.

The very small dimensions and the required shape and positional accuracies (in the few hundredths of a millimetre range) are challenging. It has accordingly been found that such a miniature quadrupole requires a design that deviates from common quadrupole construction designs and a suitable manufacturing method for series production. Common quadrupole systems, such as those with screw connections and/or fits between the RF electrodes and the insulators, cannot be manufactured with such small dimensions.

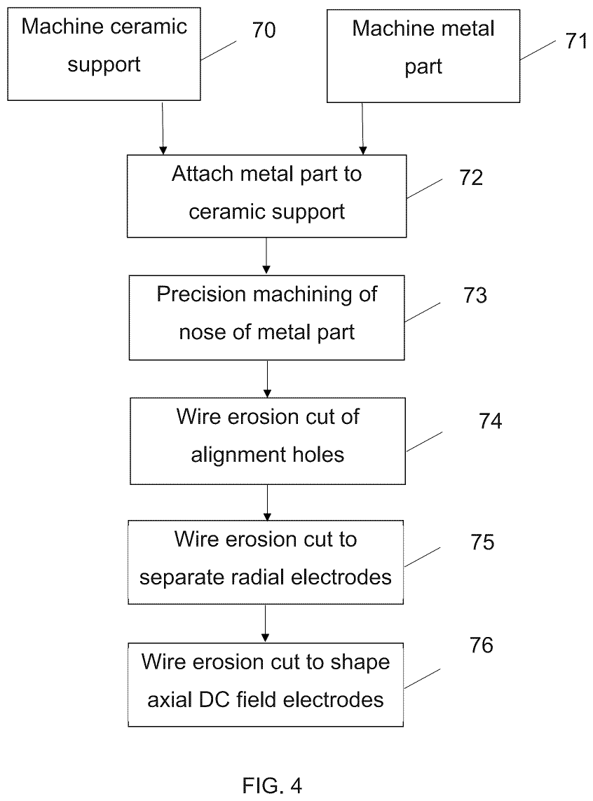

Thus, embodiments provide a method of manufacturing a miniature multipole such as a miniature quadrupole. FIG. 4 is a flow diagram illustrating the main steps in a method of manufacturing a miniature quadrupole according to embodiments. Although the process illustrated is for a quadrupole, it will be understood that the process can be used to manufacture any order of multipole, e.g. a hexapole, octopole, etc.

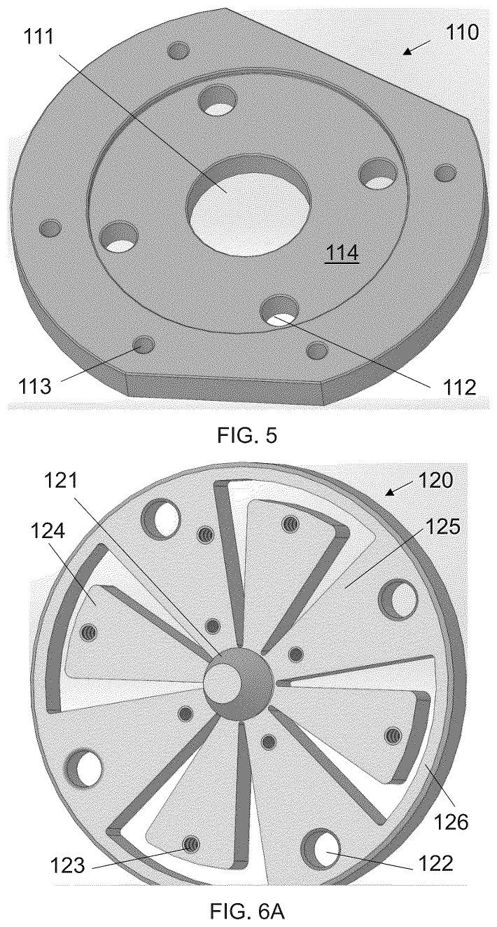

In a first step (step 70), a ceramic support is machined. FIG. 5 shows a machined ceramic support according to an embodiment. As shown in FIG. 5, the ceramic support is in the form of a ceramic ring 110 having a central hole 111 and a plurality of (e.g. three, four or more) inner alignment holes 112 arranged within a circular recess 114. A main surface of the circular recess 114 is substantially flat. The ceramic ring may also include a plurality of (e.g. five) outer threaded screw holes 113, e.g. which may be used subsequently to install the miniature quadrupole in an instrument. The ceramic support may be machined with standard tolerances using any suitable machining technique such as CNC machining.

In a second step (step 71) (which may be performed before, after or at the same time as step 70), a metal part is machined.

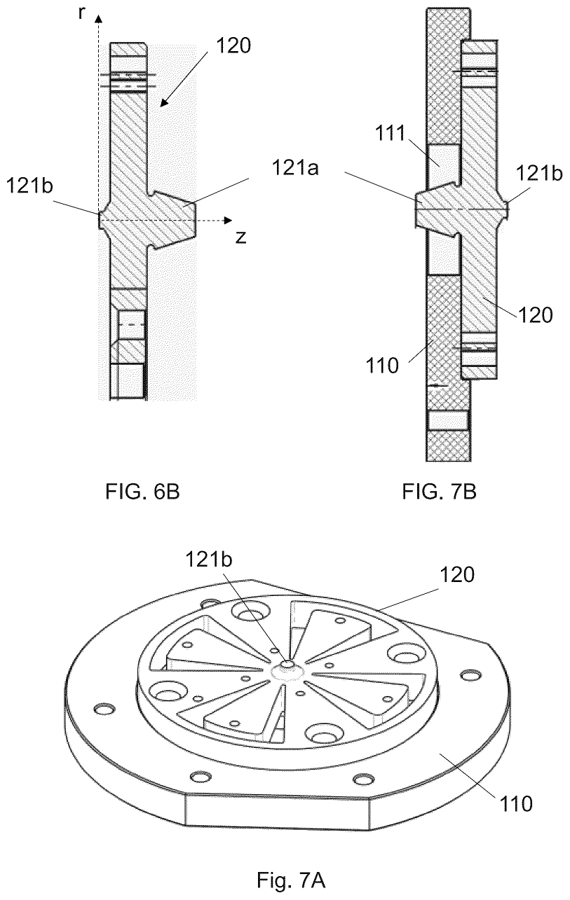

FIGS. 6A and 6B shows a machined metal part according to an embodiment. As shown in FIG. 6A, the metal part is in the form of a metal disc 120 having a central hub 121, an outer ring 126, and a plurality of initial electrodes 124, 125 extending radially outward (in a radial (r) direction) from the central hub 121 to or most of the way to the outer ring 126. The outer diameter of the metal disc 120 corresponds to the outer diameter of the ceramic ring's circular recess 114.

As shown in FIG. 6B, a main body of the metal disc 120 has main surfaces which are generally flat (except for the central hub 121), i.e. parallel to the radial (r) direction (where an axial (z) direction is orthogonal to the planes in which the surfaces are arranged). The central hub 121 protrudes from the main body of the metal disc generally in the axial (z) direction, and is in the form of a substantially frustoconical projection 121a on one side of the disc, and a smaller substantially conical projection (or “nose”) 121b on the other side of the disc.

As shown in FIG. 6A, the metal disc 120 also includes a plurality of (e.g. three, four or more) alignment holes 122, with each alignment hole 122 corresponding to a respective one of the ceramic ring's plurality of inner alignment holes 112. The metal disc 120 may also include a plurality of threaded screw holes 123, e.g. which may be used during installation of the miniature quadrupole in an instrument, e.g. for electrical and/or physical connections, and/or for contacting in the subsequent electrical discharge machining (EDM) steps.

The number of initial electrodes 124, 125 should correspond to the number of multipole electrodes that the final multipole will have. In the present embodiment, the multipole will be a quadrupole having four RF electrodes and four axial DC gradient electrodes, and so there are a total of eight initial electrodes 124, 125. It will be appreciated, however, that the principles described herein can be adapted to construct a multipole having any order (e.g. a hexapole, an octopole, etc.) with any number of axial DC gradient electrodes, in which case the metal disc should be machined accordingly to have a different number of initial electrodes.

In the embodiment depicted in FIG. 6A, the RF and DC initial electrodes 124, 125 are arranged in an alternating pattern in the angular direction around the central hub 121. Each of the initial DC electrodes 125 extends radially outward (in the radial (r) direction) from the central hub 121 to the outer ring 126, i.e. each of the initial DC electrodes 125 contacts the central hub 121 and the outer ring 126. Thus, the initial DC electrodes 125 are electrically (and physically) connected to one another by the outer ring 126. On the other hand, each of the initial RF electrodes 124 extends radially outward (in the radial (r) direction) from the central hub 121 most of the way (but not all the way) to the outer ring 126, i.e. the initial RF electrodes 124 are each connected only to the central hub 121 and not to the outer ring 126 (nor to any other part of the metal disc).

The metal disc 120 may be formed from any suitable metal, such as for example, Kovar™, which is a nickel-cobalt ferrous alloy designed to have substantially the same thermal expansion characteristics as ceramic. Thus, when the ceramic ring 110 and the metal disc 120 are attached to one another, a ceramic/metal pairing is provided that has the same thermal expansion properties to prevent stress. The metal disc may be machined with standard tolerances using any suitable machining technique such as electrical discharge machining (EDM).

Once the ceramic support and the metal part have been machined, the next step is to attach them to one another (step 72).

As shown in FIGS. 7A and 7B, the metal disc 120 is arranged in the recess 114 of the ceramic ring 110, with the respective alignment holes 112, 122 aligned with one another, and the frustoconical projection 121a of the metal disc projecting through the central hole 111 of the ceramic ring. Respective flat surfaces of the metal disc 120 and the recess 114 are bonded by brazing. In particular, the metal disc 120 is brazed onto the ceramic ring 110 at high temperature (e.g. around 800° C.) with active solder. The solder compound is selected to be suitable for ultra-high vacuum and is mechanically and thermally very resilient.

FIG. 7A shows schematically the initial brazed assembly, with the pre-machined initial electrodes of the metal disc 120 facing upwards. It will be appreciated that at this stage, the metal disc 120 already has a prefabricated contour, from which the miniature quadrupole electrodes and mounting holes are to be carved out in subsequent precision machining steps. The metal part has been worked so far such that the subsequent precision manufacturing steps only need to remove a small amount of material. This increases accuracy and minimises material distortion.

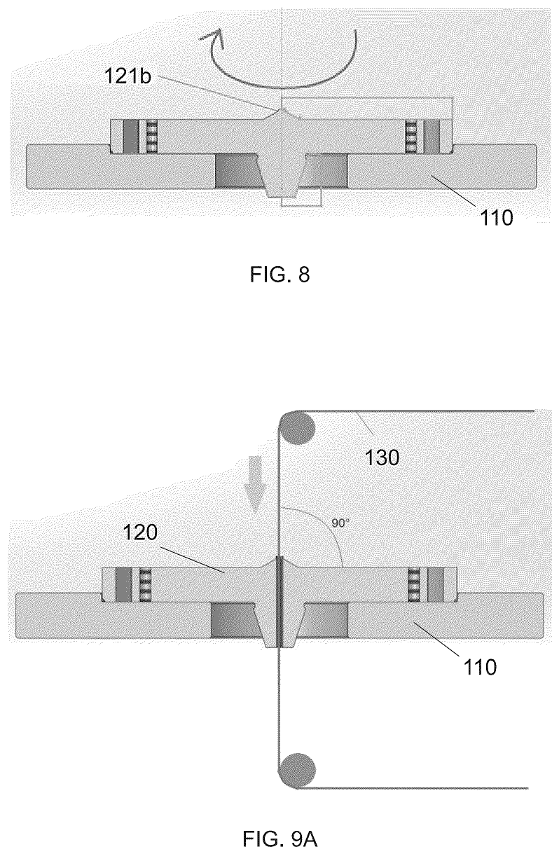

Next, the nose 121b of the metal disc is further machined (step 73). As illustrated in FIG. 8, the nose 121b of the metal disc is precisely machined by turning. This step allows the machined nose 121b to act as a precise alignment shaft, i.e. where the machined nose 121b is well centred and acts a reference point, to improve the precision of the subsequent wire erosion steps.

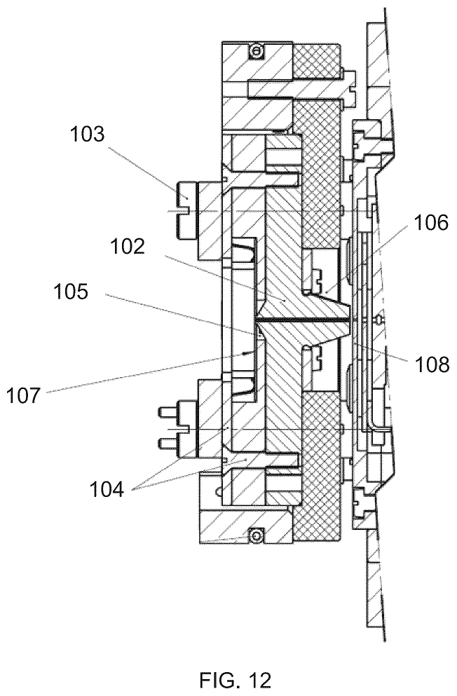

In a first wire erosion step (step 74), the alignment holes 122 of the metal disc are further machined by precision wire erosion. Note that the ceramic ring's alignment holes 112 may have a diameter that is larger than the diameter of the metal disc's alignment holes 122, e.g. so that the ceramic ring does not interfere with this wire erosion step (and so that the final minimum diameter of the alignment holes 112, 122 is defined by the diameter of the metal disc's alignment holes 122 of after the wire erosion step 74). The alignment holes 122 are subsequently used when installing the miniature quadrupole in an analytical instrument to align it relative to other ion optical components of the instrument (as is described further below with respect to FIG. 12). By prefabricating the alignment holes 122 with standard tolerances (in step 71) and then precisely machining the alignment holes 122 (in step 74), the precision manufacturing step must only remove a small amount of material, thereby increasing accuracy and minimising material distortion.

Next, a precision wire erosion cut is used to separate the initial electrodes 124, 125 and to create the miniature multipole's RF and DC electrodes (step 75). The cut is made with the wire of the wire erosion machine arranged parallel to the axial (z) direction and is made such that the cut extends all the way through the nose 121b, the main body of the metal disc 120, and the frustoconical projection 121a.

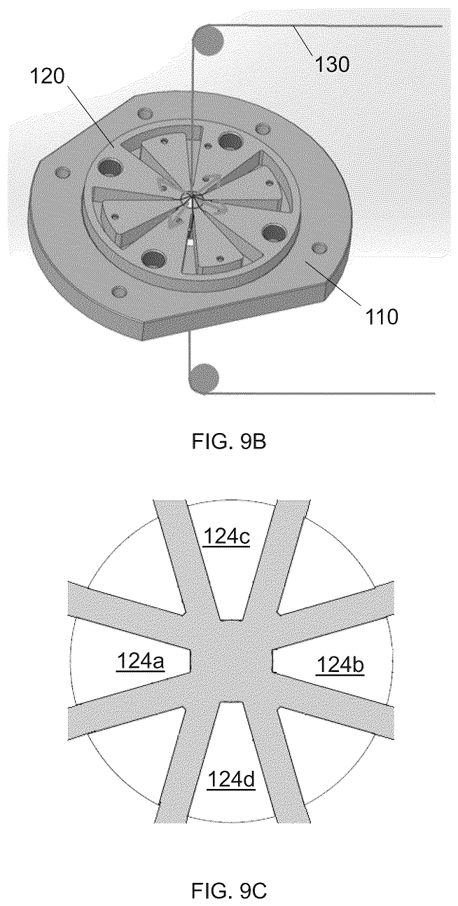

FIG. 9A illustrates this step schematically. In FIG. 9A, a pre-cut hole or slot (“start-hole”) has been made through the centre of the metal disc, and the wire 130 of the wire erosion machine has been threaded through the start hole. The start hole extends along the axial (z) direction and can be made using any suitable technique such as drilling or sinker EDM. As also illustrated in FIG. 9A, the wire 130 of the wire erosion machine runs continuously over two rolls (in the axial (z) direction). The arrow in FIG. 9A illustrates the feed direction of the wire 130, along which it is continuously moved.

As best illustrated by the arrows in FIG. 9B, this “rolling” wire 130 is then moved in directions orthogonal to the axial (z) direction (e.g. in the x and y directions) with a voltage applied between the wire 130 and the disc 120 to cut the metal disc 120.

FIG. 9C is illustrative of the cut that is made by the precision wire erosion cut of step 75 to separate the initial electrodes and to create the miniature multipole's RF and DC electrodes. In FIG. 9C, the circle is illustrative of a head-on view of the nose 121b of the metal disc. The shaded regions are illustrative of regions of the metal disc that are removed by the wire erosion cut. The cut comprises a square or rectangular region at the centre of the nose 121b as well as eight lines extending radially outwardly from the centre of the nose 121b. Each of the lines of the cut correspond to one of the regions between adjacent initial electrodes 124, 125 of the metal disc, so that the initial electrodes 124, 125 are separated from one another. Thus, after this cut, the DC electrodes 125 are electrically connected to one another only by the outer ring 126, while the RF electrodes 124 are each electrically isolated from one another (and from all other parts of the metal disc 120) (but are physically connected to and supported by the ceramic support 110).

This cut is configured such that after the cut, the RF electrodes of the miniature multipole are suitably shaped. In particular, as shown in FIG. 9C, the four RF multipole electrodes 124a, 124b, 124c, 124d are arranged in a quadrupolar configuration, with each RF multipole electrode extending generally along the axial (z) direction and having a flat face running parallel to the axial (z) direction.

Step 74 may be performed before, after, or substantially at the same time as (e.g. as part of the same wire erosion step) step 75.

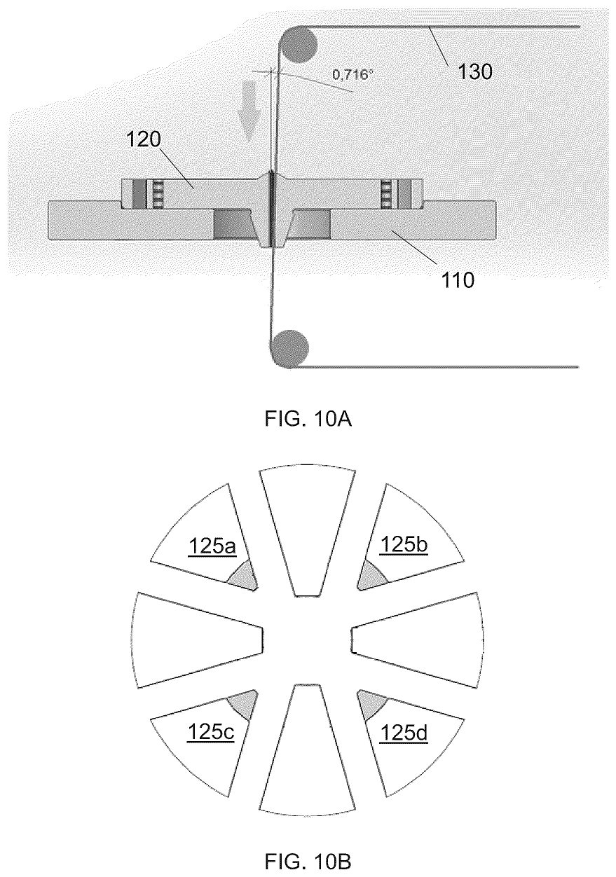

In a final machining step (step 76), a second precision wire erosion cut is used to shape the axial DC gradient electrodes 125. As illustrated in FIG. 10A, to do this, the wire 130 of the wire erosion machine is tilted slightly relative to the plain of the metal disc (or vice versa), and a cut is made to the ends of each of the radial DC electrodes 125. Thus, the cut is made with the wire 130 of the wire erosion machine arranged at a small angle relative to the axial (z) direction. In the embodiment depicted in FIG. 10A, the wire 130 is arranged at an angle of 0.716° relative to the axial (z) direction, but other suitable angles could be used, such as a non-zero (e.g. >0.1°, >0.2°, or >0.5°) angle of about <5°, <2°, or <1° relative to the axial (z) direction. This cut again extends all the way through the nose 121b, the main body of the metal disc 120, and the frustoconical projection 121a.

FIG. 10B is illustrative of the cut that is made by the second precision wire erosion cut of step 76 to shape the axial DC gradient electrodes 125. In FIG. 10B, the shaded regions are again illustrative of regions of the metal disc that are removed by the wire erosion cut. However, in FIG. 10B, not all of the material in the shaded regions is removed; rather, the shaded regions are indicative of angled surfaces created by the wire erosion cut.

This cut is configured such that after the cut, the DC electrodes of the miniature quadrupole are suitably shaped. In particular, as shown in FIG. 10B, each of the four DC electrodes 125a, 125b, 125c, 125d is arranged between one of the RF electrodes, with each DC electrode extending generally in the axial (z) direction and having a flat face which is arranged at a small angle relative to the axial (z) direction. Thus, this second EDM step creates a conical shape for the axial DC gradient electrodes, i.e. such that the axial DC gradient electrodes are suitable for supplying an axial gradient field (along the axial (z) direction) within the miniature quadrupole.

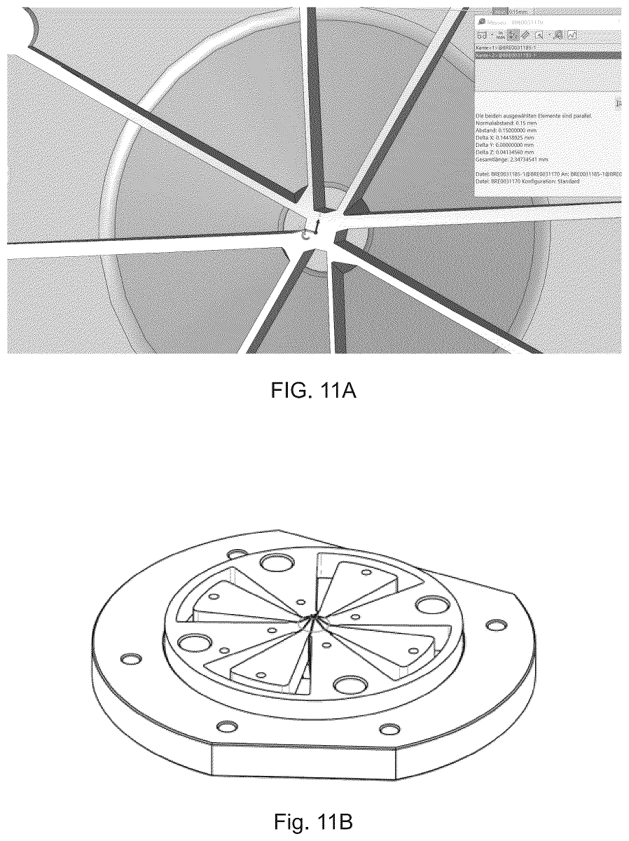

FIG. 11A shows schematically a close-up perspective view of the final miniature quadrupole and FIG. 11B shows schematically a perspective view of the final wire-eroded miniature quadrupole assembly. As can be seen in FIG. 11A, the miniature quadrupole comprises four RF electrodes arranged in a quadrupole configuration, with four axial DC gradient electrodes arranged between the RF electrodes. In some embodiments, the RF electrodes extend beyond the axial DC gradient electrodes in the axial (z) direction. This allows the RF electrodes to be connected to another RF ion optical device such as an ion carpet.

FIG. 12 shows schematically a cross-sectional view of the final wire-eroded miniature quadrupole assembly when installed within an analytical instrument, such as the instrument depicted in FIG. 2. The miniature quadrupole 102 is precisely aligned to other ion optical components of the instrument using alignment bolts 103 which pass through the alignment holes 112, 122. Electrical contact is made to the miniature quadrupole 102 via an adapter PCB 104. The miniature quadrupole 102 is surrounded by a gas filled region 105 and a vacuum pumped region 106, with assemblies 107, 108 having apertures arranged in front of and behind of, and aligned with, the miniature quadrupole 102.

The miniature quadrupole described herein has very small dimensions and requires very precise manufacturing accuracies for this kind of pole rod system (with two pairs of RF electrodes and a superimposed axial DC field) which can be used to generate and focus a very small width ion beam. The combination of electrically insulating ceramics as a solid (brazed) base for the metal electrodes and the final precision machining with very thin EDM wire (e.g. about 0.1 mm), allows accuracies for the rod electrodes of about ±0.01 mm with a gap width of <0.2 mm, such as around 0.15 mm, between the individual electrodes. This is in contrast with known quadrupoles, which are generally much larger and are not equipped with axial field electrodes.

It will be appreciated that embodiments provide various benefits, including: (i) very small dimensions with high accuracy, for use in mass spectrometer systems where very small ion beams are required; (ii) good possibility for precise alignment in ion-optical assemblies (i.e. centring to other components); (iii) production-ready manufacturing method with reproducible quality; (iv) mechanically and thermally resilient and compact (robust) design; (v) ultrahigh vacuum compatible; (vi) the system can be cleaned (e.g. rinsed) without disassembly, which might otherwise change the accuracy of the quadrupole; (vii) due to the EDM process, accuracies of ±0.01 mm can be achieved, with pole bar spacing (gaps) of around 0.15 mm; and (viii) gas filling is possible by using a front aperture (cover) and a large clearance for vacuum pumping.

Although various embodiments have been described above, various alternatives are possible. For example, variants of the support are possible, e.g. rings could be arranged around the pole rods instead of using a flat ceramic support.

Although embodiments described above are particularly directed to manufacturing of a quadrupole having four RF electrodes and four axial DC gradient electrodes, the principles described herein can be adapted to construct a multipole having any order (e.g. a hexapole, an octopole, etc.) with any number of one or more axial DC gradient electrode(s).

Although the present invention has been described with reference to various embodiments, it will be understood that various changes may be made without departing from the scope of the invention as set out in the accompanying claims.

1. A method of manufacturing a multipole ion guide, the method comprising:
providing a metal part;
cutting the metal part by wire erosion in a first step to create a plurality of multipole electrodes that each extend generally along an axial (z) direction, wherein the plurality of multipole electrodes includes a plurality of RF electrodes and one or more axial DC gradient electrodes; and
cutting the metal part by wire erosion in a second step to shape each of the one or more axial DC gradient electrodes;
wherein in the first wire erosion step, a wire erosion wire is arranged to extend in a first direction, wherein the first direction is substantially parallel to the axial (z) direction; and
wherein in the second wire erosion step, a wire erosion wire is arranged to extend in one or more second direction(s), wherein each second direction is arranged at a non-zero angle relative to the first direction.

2. The method of claim 1, wherein each second direction is arranged at a non-zero angle <5° relative to the first direction and/or wherein each second direction is arranged at an angle >0.1° relative to the first direction.

3. The method of claim 1, wherein the plurality of multipole electrodes includes a plurality of axial DC gradient electrodes, and wherein in the second wire erosion step each axial DC gradient electrode is cut such that the axial DC gradient electrodes together have a substantially conical profile.

4. The method of claim 1, wherein the metal part comprises a metal disc having a central hub, an outer ring, and a plurality of initial electrodes that each extend radially from the central hub towards the outer ring.

5. The method of claim 4, wherein in the first wire erosion step, the initial electrodes are separated from one another.

6. The method of claim 5, wherein:
the plurality of initial electrodes comprises a plurality of initial RF electrodes and a plurality of initial DC electrodes;
each of the initial DC electrodes extends radially from the central hub to the outer ring; and
each of the initial RF electrodes extends radially from the central hub some but not all of the way to the outer ring.

7. The method of claim 6, wherein:
the initial RF electrodes and the initial DC electrodes are arranged in an alternating pattern around the central hub; and
in the first wire erosion step, the initial RF electrodes are separated from the initial DC electrodes.

8. The method of claim 4, wherein the central hub protrudes from a main body of the metal disc generally in the axial (z) direction, and is in the form of a substantially frustoconical projection on one side of the disc, and a substantially conical projection on the other side of the disc.

9. The method of claim 8, wherein the metal part is attached to an insulating support.

10. The method of claim 9, wherein the method comprises attaching the metal part to the insulating support by brazing.

11. The method of claim 9, wherein:
the insulating support comprises a ring having a central hole arranged within a recess; and
the method comprises arranging the metal disc in the recess, with the frustoconical projection of the metal disc projecting through the central hole.

12. The method of claim 11, wherein:
a surface of the recess is substantially flat;
a surface of the main body of the metal disc is substantially flat; and
the method comprises bonding the flat surface of the metal disc to the flat surface of the recess by brazing.

13. The method of claim 11, wherein:
the ring comprises a plurality of alignment holes arranged within the recess;
the metal disc comprises a plurality of alignment holes, with each alignment hole corresponding to a respective one of the alignment holes of the ring; and
the step of arranging the metal disc in the recess comprises aligning the alignment holes of the metal disc with the alignment holes of the ring.

14. The method of claim 9, further comprising machining the conical projection by turning after attaching the metal part to the insulating support.

15. The method of claim 1, further comprising cutting the metal part by wire erosion to shape a plurality of alignment holes.

16. The method of claim 1, wherein the metal part is formed from a nickel-cobalt ferrous alloy having substantially the same thermal expansion characteristics as ceramic.

17. The method of claim 1, wherein the wire erosion wire has a diameter <0.2 mm and/or wherein the plurality of multipole electrodes are separated from one another by gaps, with each gap having a width <0.2 mm.

18. The method of claim 1, wherein the plurality of multipole electrodes each have a length in the axial (z) direction of <20 mm.

19. A multipole ion guide manufactured according to the method of claim 1.

20. An analytical instrument comprising the multipole of claim 19.
